(19) United States
(12) Patent Application Publication
(10) Pub. No.: US 2026/0197160 A1
(43) Pub. Date: Jul. 9, 2026

(54) Universal Quantum Access Key ,UQAK,The Gateway to Eden, Wealth, and Infinite Possibilities for Every Person, Family, Industry, and Nation

(71) Applicant: FURONG BEI, SAN GABRIEL, CA (US)

(72) Inventor: FURONG BEI, SAN GABRIEL, CA (US)

(21) Appl. No.: 19/086,150

(22) Filed: Mar. 21, 2025

Related U.S. Application Data
(63) Continuation-in-part of application No. 19/083,396, filed on Mar. 18, 2025.
(63) Continuation-in-part of application No. 19/072,412, filed on Mar. 6, 2025.
(63) Continuation-in-part of application No. 19/073,040, filed on Mar. 7, 2025.
(63) Continuation-in-part of application No. 19/066,022, filed on Feb. 27, 2025, now abandoned.
(63) Continuation-in-part of application No. 19/069,285, filed on Mar. 4, 2025.
(63) Continuation-in-part of application No. 19/060,652, filed on Feb. 22, 2025, now abandoned.
(63) Continuation-in-part of application No. 19/064,689, filed on Feb. 27, 2025.
(63) Continuation-in-part of application No. 19/072,075, filed on Mar. 6, 2025.
(63) Continuation-in-part of application No. 19/070,545, filed on Mar. 5, 2025.
(63) Continuation-in-part of application No. 19/053,406, filed on Feb. 13, 2025, now abandoned.
(63) Continuation-in-part of application No. 19/069,268, filed on Mar. 4, 2025.
(63) Continuation-in-part of application No. 19/073,058, filed on Mar. 7, 2025.
(63) Continuation-in-part of application No. 19/083,371, filed on Mar. 18, 2025.
(63) Continuation-in-part of application No. 19/074,352, filed on Mar. 8, 2025.
(63) Continuation-in-part of application No. 19/082,758, filed on Mar. 18, 2025.
(63) Continuation-in-part of application No. 19/078,276, filed on Mar. 13, 2025.
(63) Continuation-in-part of application No. 19/059,289, filed on Feb. 21, 2025, now abandoned.
(63) Continuation-in-part of application No. 19/073,042, filed on Mar. 7, 2025.
(63) Continuation-in-part of application No. 19/051,584, filed on Feb. 12, 2025, now abandoned.
(63) Continuation-in-part of application No. 19/078,271, filed on Mar. 12, 2025.
(63) Continuation-in-part of application No. 19/067,936, filed on Mar. 2, 2025.
(63) Continuation-in-part of application No. 19/070,548, filed on Mar. 5, 2025.
(63) Continuation-in-part of application No. 19/080,825, filed on Mar. 15, 2025.
(63) Continuation-in-part of application No. 19/059,324, filed on Feb. 21, 2025, now abandoned.
(63) Continuation-in-part of application No. 19/067,845, filed on Mar. 1, 2025.
(63) Continuation-in-part of application No. 19/069,264, filed on Mar. 4, 2025.
(63) Continuation-in-part of application No. 19/079,378, filed on Mar. 13, 2025.
(63) Continuation-in-part of application No. 19/051,353, filed on Feb. 12, 2025, now abandoned.
(63) Continuation-in-part of application No. 19/066,179, filed on Feb. 28, 2025, now abandoned.
(63) Continuation-in-part of application No. 19/067,888, filed on Mar. 1, 2025, now abandoned.
(63) Continuation-in-part of application No. 19/067,732, filed on Feb. 28, 2025.
(63) Continuation-in-part of application No. 19/072,905, filed on Mar. 6, 2025.
(63) Continuation-in-part of application No. 19/059,110, filed on Feb. 20, 2025, now abandoned.
(63) Continuation-in-part of application No. 19/053,450, filed on Feb. 14, 2025, now abandoned.
(63) Continuation-in-part of application No. 19/069,278, filed on Mar. 4, 2025.
(63) Continuation-in-part of application No. 19/054,778, filed on Feb. 15, 2025, now abandoned.
(63) Continuation-in-part of application No. 19/058,739, filed on Feb. 20, 2025.
(63) Continuation-in-part of application No. 19/056,745, filed on Feb. 19, 2025.
(63) Continuation-in-part of application No. 19/060,403, filed on Feb. 21, 2025, now abandoned.
(63) Continuation-in-part of application No. 19/060,663, filed on Feb. 22, 2025.
(63) Continuation-in-part of application No. 19/072,953, filed on Mar. 6, 2025.
(63) Continuation-in-part of application No. 19/069,257, filed on Mar. 4, 2025.
(63) Continuation-in-part of application No. 19/069,205, filed on Mar. 3, 2025.
(63) Continuation-in-part of application No. 19/057,393, filed on Feb. 19, 2025, now abandoned.
(63) Continuation-in-part of application No. 19/067,907, filed on Mar. 2, 2025.
(63) Continuation-in-part of application No. 19/083,357, filed on Mar. 18, 2025.
(63) Continuation-in-part of application No. 19/057,972, filed on Feb. 19, 2025, now abandoned.
(63) Continuation-in-part of application No. 19/076,910, filed on Mar. 11, 2025.
(63) Continuation-in-part of application No. 19/083,345, filed on Mar. 18, 2025.
(63) Continuation-in-part of application No. 19/074,355, filed on Mar. 8, 2025.
(60) Provisional application No. 63/759,784, filed on Feb. 18, 2025.

(51) Int. Cl. H04L 9/08; G06Q 30/018; H04L 9/00; H04L 9/32

(52) U.S. Cl. CPC H04L 9/0852; G06Q 30/018; H04L 9/3213; H04L 9/50; G06Q 2220/00

(57) ABSTRACT

A computer-implemented Universal Quantum Access Key (UQAK) system provides quantum-secure identity authentication, policy-controlled authorization, domain-namespace routing, and interoperable settlement. A namespace resolver resolves a human-readable identifier, parcel identifier, subdomain identifier, or basepoint identifier to a signed endpoint record. An identity module authenticates a subject identity anchor. An event-ingestion module receives a digitally signed event record, transaction request, evidence commitment, or terminal-originated payment event. A Time-Proof engine binds the event to a time reference, validity window, and anti-replay value. A policy container loads a signed, versioned policy bundle or PackSet. A transaction authorization and minting engine executes a single atomic state transition that authorizes a protected action, binds an associated token, value unit, certificate, entitlement, or authorization state, generates a decision or mint receipt, and anchors a digest in a tamper-evident data structure. A clearing and settlement module generates a settlement receipt.

### CROSS-REFERENCE TO RELATED APPLICATIONS

This application is drafted as an integrated filing set for a universal quantum-secure identity, policy-controlled authorization, domain-namespace routing, interoperable minting, and multi-rail settlement architecture. Domestic benefit, continuity, and priority relationships for any continuation, divisional, or continuation-in-part practice are intended to be made in a corresponding Application Data Sheet. The present specification is written to preserve and consolidate core subject matter from multiple still-relevant earlier applications and related application branches while maintaining a unified technical spine.

Principal parent candidates for the core architecture include the following United States applications, each of which contributes support to one or more portions of the identity, authorization, time-governance, minting, routing, or settlement stack: Ser. No. 19/060,663 (risk-controlled transaction authorization, hardware-rooted signing, offline approval, and audit reconstruction); Ser. No. 19/067,732 (sovereign financial identity, domain deployment, reversible clearing, federated AI risk control, zero-knowledge audit, and post-quantum upgrade path); Ser. No. 19/084,779 (decentralized identity, zero-knowledge proof authentication, biometric authentication, cross-chain identity verification, and quantum-resistant credentials); Ser. No. 19/432,049 (time-governance, policy-pack evaluation, evidence, denial, rollback, and settlement receipts, bounded rollback, and gated observability); Ser. No. 19/438,575 (time-currency, Time-Proof processing, minting, clearing, audit, naming, interoperability, and selective audit); and Ser. No. 19/073,574 (decentralized identity, predicate-based zero-knowledge proof, policy-enforced authorization state machine, namespace-to-identity binding, tokenized entitlements, and oracle-assisted settlement).

Additional earlier finance and infrastructure roots, each preserved for use as support reservoirs, continuation-in-part inputs, or continuity candidates to the extent permitted by law and set forth in the Application Data Sheet, include: Ser. No. 19/064,689 (registry control, domain deployment, swap, freeze, selective disclosure, and incentive mechanisms); Ser. No. 19/066,022 (banking risk control, multi-signature approval, distributed auditing, automated compliance, collateralization, and incentive mechanisms); Ser. No. 19/066,179 (orchestration backbone, routing contracts, governance architecture, cross-chain adapters, and AI, privacy, and energy-management infrastructure); Ser. No. 19/067,888 (financial interoperability, second-level domain identity, standards bridge, quantum key distribution, quantum random-number generation, and dual-layer authorization); Ser. No. 19/067,845 (credit scoring, multi-party computation, zero-knowledge proof, AI risk analytics, and data governance); Ser. No. 19/067,936 (supply-chain provenance, anti-counterfeiting, inventory analytics, and supply-chain finance); Ser. No. 19/072,412 (real-time payment processing, foreign-exchange optimization, route selection, settlement, and compliance and fraud intervention); Ser. No. 19/072,953 (asset collateralization, AI valuation, risk thresholding, and real-time liquidation); Ser. No. 19/072,075 (quantum-secured finance, AI credit management, governance architecture, co-ownership tokens, cross-chain payment gateway, and human-machine interface); Ser. No. 19/074,355 (multi-dimensional financial security, distributed network routing, AI dynamic risk control, smart-contract security, and quantum-resistant encryption); Ser. No. 19/074,352 (AI-driven autonomous banking, asset tokenization, NFT fractionalization, collateralized lending, decentralized governance, and immutable reporting); Ser. No. 19/076,910 (decentralized identity, NFT collateral, governance architecture, digital-asset verification, and cross-chain digital-asset governance); Ser. No. 19/078,271 (decentralized identity, decentralized finance, governance architecture, NFT asset verification, AI-regulated smart contracts, and settlement); and Ser. No. 19/079,378 (decentralized payment and settlement, NFT collateralization, AI liquidity management, self-sovereign identity, know-your-customer and anti-money-laundering controls, and quantum-resistant security).

Related applications that are not necessarily intended as principal priority roots for every claim set, but that preserve important related branches for exchange, digital land, upgrade governance, naming, registry, or market infrastructure, include: Ser. No. 19/403,879 (exchange infrastructure, securities standards, asset registry, and domain-based instruments); Ser. No. 19/411,327 (payment-to-mint architecture, terminal behavior minting, merchant-zero-fee operation, and payment governance); Ser. No. 19/073,040 (upgradeable smart contracts, proxy-implementation architecture, role-based access control, multi-signature version control, rollback, and audit security); Ser. No. 19/073,778 (digital land, NFT parcel governance, and hierarchical subdomain governance); Ser. No. 19/448,144 (domain-name resolution, policy-governed naming, resolution receipts, object binding, and bounded rollback); and Ser. No. 19/058,739 (domain and namespace lattice, and decentralized finance, privacy, and compliance infrastructure).

Additional related United States applications preserved for branch visibility and, where legally appropriate and expressly set forth in the Application Data Sheet, as potential domestic-benefit or continuity candidates include: Ser. No. 19/078,276 (identity, authorization, routing, settlement, and audit infrastructure); Ser. No. 19/080,825 (policy-controlled transaction and settlement infrastructure); Ser. No. 19/082,758 (control, routing, governance, and infrastructure subject matter); Ser. No. 19/083,345 (control, governance, and infrastructure subject matter); Ser. No. 19/083,357 (control, governance, and infrastructure subject matter); Ser. No. 19/083,371 (control, governance, and infrastructure subject matter); Ser. No. 19/083,396 (control, governance, and infrastructure subject matter); Ser. No. 19/083,430 (governance and settlement subject matter); Ser. No. 19/084,753 (decentralized identity, authorization-state, and namespace-linked subject matter); Ser. No. 19/084,806 (banking, transaction, claim, and settlement infrastructure); and Ser. No. 19/085,925 (health-system and sector-application implementation subject matter).

Sector-application branches include: Ser. No. 19/069,264 (domain-token architecture, biosensor integration, and screen-based health monitoring and alerting applications); Ser. No. 19/069,268 (asset tracking, secondary naming tokens, anti-theft operation, and provenance implementation); Ser. No. 19/069,278 (vehicle safety and smart-driving implementation); and Ser. No. 19/069,285 (pet internet-of-things, pet NFT, and smart animal-health implementation).

Separate branches preserved for independent family development include Ser. No. 19/067,907 (medical diagnostics for cervical and breast cancer detection) and Ser. No. 19/069,205 (oncology therapeutics, gene editing, oncolytic virus, and RNA and lipid-nanoparticle treatment).

Where permitted by law and to the extent not inconsistent with the present disclosure, the disclosures of the above applications may be incorporated by reference for contextual, implementation, branch, or ecosystem support; however, such incorporation is not intended to substitute for an Application Data Sheet domestic benefit claim, nor to cure a lack of written-description support where required by applicable law.

### TECHNICAL FIELD

The invention relates to digital identity, secure transaction processing, distributed ledger systems, interoperable settlement infrastructure, cryptographic policy enforcement, and programmable asset and entitlement management.

More particularly, the invention concerns a universal access and settlement architecture that combines decentralized identity authentication, quantum-secure or quantum-resistant cryptographic techniques, machine-verifiable policy control, domain-namespace routing, time-governed proofs and receipts, interoperable minting and clearing, tokenized rights management, and multi-sector application support.

### BACKGROUND OF THE INVENTION

Modern digital systems remain fragmented across identity, payments, governance, healthcare, education, property, logistics, mobility, and asset-management environments. Subjects are repeatedly authenticated in incompatible systems, entitlements are issued under disconnected rules, and settlement commonly occurs on delayed or opaque rails.

Existing systems often separate identity verification, risk control, policy enforcement, authorization, minting, and settlement into isolated layers that do not share a consistent evidence or receipt framework. This fragmentation creates latency, duplicate compliance overhead, weak auditability, limited rollback control, and poor cross-system portability.

Conventional systems also treat domain names, subdomains, parcels, namespace roots, digital-land rights, registry objects, and related programmable identifiers as disconnected from identity and authorization. Similarly, many token systems fail to bind rights, eligibility, remediations, and machine-readable authorization outcomes to the same cryptographically verifiable control fabric.

Existing payment and settlement platforms frequently lack a unified mechanism for route optimization, bounded authorization, cross-currency execution, collateral handling, liquidation control, or machine-verifiable transition receipts. Fraud detection, policy gating, and risk scoring may occur externally to the transition path, leaving poor evidence continuity.

Separate real-world and sector-specific systems such as supply-chain provenance, device and pet identity, mobility, healthcare alerts, digital-land governance, upgradeable contract management, and exchange or securities infrastructure likewise often operate with incompatible identity, policy, and settlement assumptions.

A need therefore exists for a single technical architecture capable of authenticating a subject or object, applying machine-verifiable policy, enforcing time-bounded validity and bounded authorization outcomes, binding tokens and entitlements to identity or namespace objects, generating append-only receipts, supporting interoperable minting and settlement, and extending the same control spine into multiple sector-specific applications.

A further need exists for a filing architecture that can preserve earlier roots in identity, finance, governance, registry, security, and sector-application branches while presenting a coherent, technically useful, and commercially licensable integrated system.

### SUMMARY OF THE INVENTION

In one aspect, the invention provides a computer-implemented system including a namespace resolver, an identity module, an event-ingestion module, a Time-Proof engine, a policy container, an asset management module, a transaction authorization and minting engine, and a clearing and settlement module. The modules cooperate to generate a single machine-verifiable spine for identity, proof, authorization, entitlements, receipts, and settlement.

In another aspect, the invention provides a method in which a subject identity anchor or object anchor is authenticated, an event or request is received, a Time-Proof is generated or verified, a policy bundle or PackSet is applied, a bounded authorization outcome is selected, and a cryptographically anchored decision or settlement receipt is recorded.

In another aspect, the invention provides machine-readable instructions for implementing the same architecture on one or more computing systems, including in cloud deployments, edge terminals, validator nodes, exchange gateways, registry nodes, or sector-specific device environments.

In still further aspects, the invention provides optional extensions for payment-to-mint conversion, collateralization and liquidation, digital-land and subdomain governance, upgradeable contract control, route optimization, AI-driven credit and fraud management, quantum-secure communication, and sector-application implementations including health, supply chain, mobility, pet and device identity, and IoE applications.

The invention thereby improves computer functionality by reducing fragmentation, enforcing machine-verifiable policy and temporal validity inside the authorization path, generating tamper-evident decision and settlement receipts, enabling domain-namespace driven routing and entitlement binding, and providing a single technical spine capable of licensing, transfer, or deployment across multiple commercial and sovereign contexts.

The same integrated technical architecture also improves the valuation and transferability of related intellectual-property assets because the system is organized as a modular but coherent stack with identifiable core parents, related branches, and sector-application embodiments.

### BRIEF DESCRIPTION OF THE DRAWINGS

FIG. 1 illustrates an overall architecture of the UQAK system including identity, policy, minting, settlement, and receipt layers.

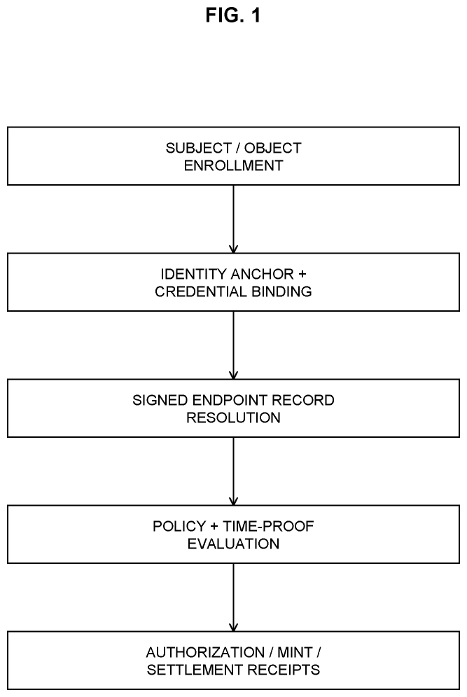

FIG. 2 illustrates subject enrollment, DID issuance, biometric or credential binding, and predicate-proof verification.

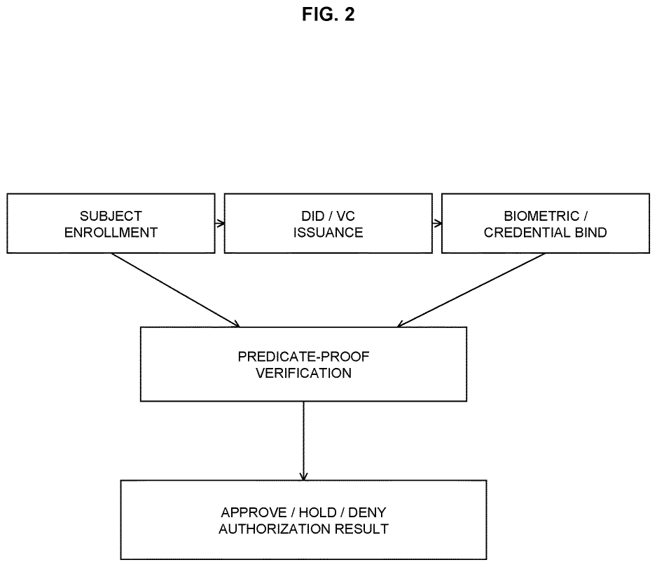

FIG. 3 illustrates namespace resolution and signed endpoint record discovery for identity, policy, audit, minting, exchange, and settlement endpoints.

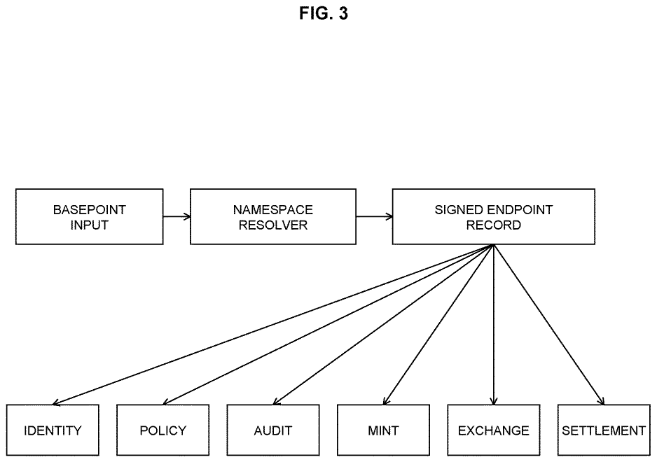

FIG. 4 illustrates Time-Proof generation, validity-window enforcement, replay prevention, and PackSet evaluation.

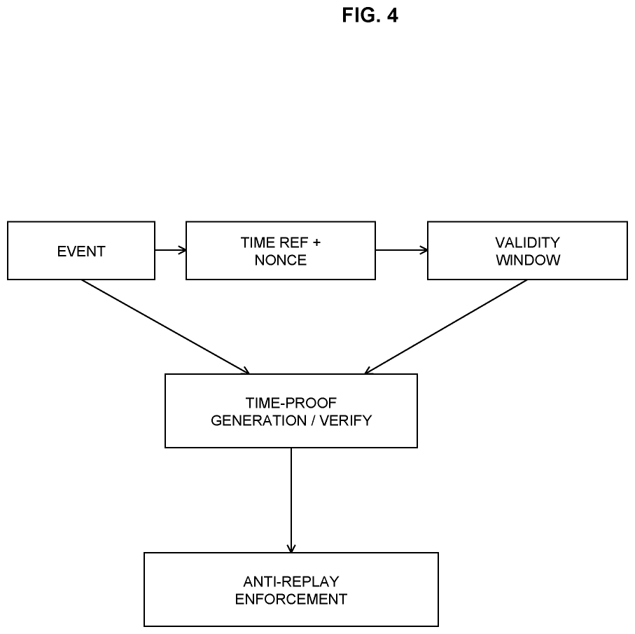

FIG. 5 illustrates an authorization finite-state machine producing approve, deny, hold, limit, remediation, and rollback-eligible outcomes.

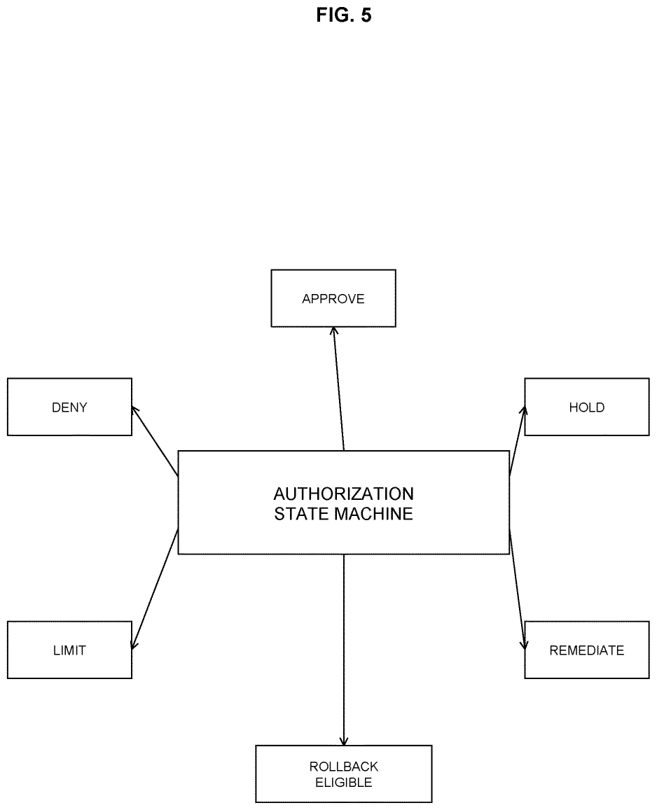

FIG. 6 illustrates payment-to-mint transformation, vault allocation, and decision/settlement receipt anchoring.

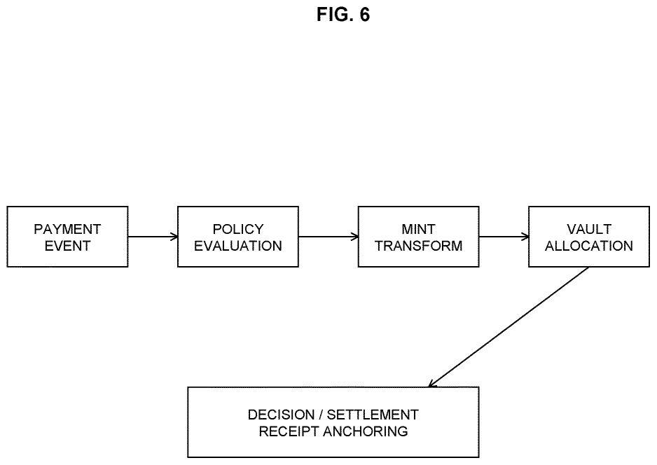

FIG. 7 illustrates route selection, foreign-exchange optimization, oracle-assisted multi-currency settlement, and compliance-aware execution.

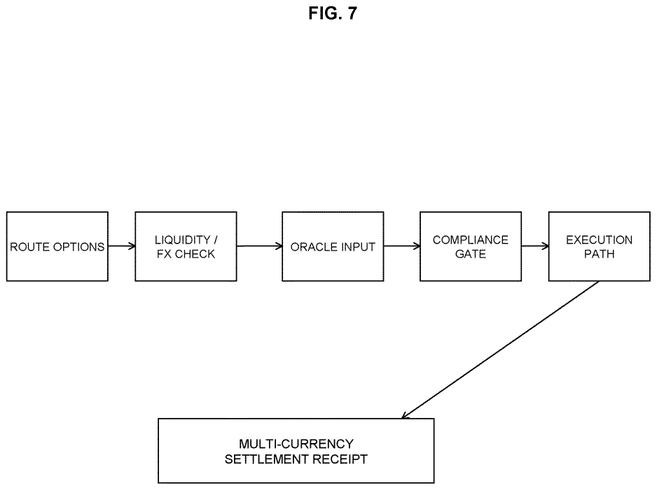

FIG. 8 illustrates collateralization, valuation, risk-threshold determination, and automated liquidation pathways.

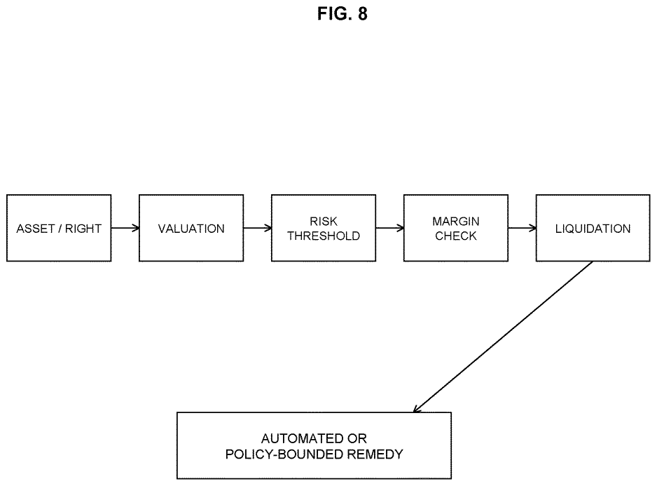

FIG. 9 illustrates BEIGX, BEISEC, registry, listing, and exchange interactions for tokenized assets and securities-style instruments.

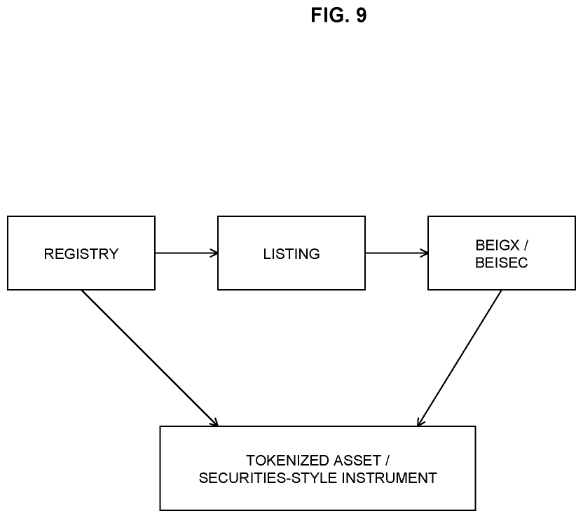

FIG. 10 illustrates digital-land, parcel, and hierarchical subdomain issuance and governance.

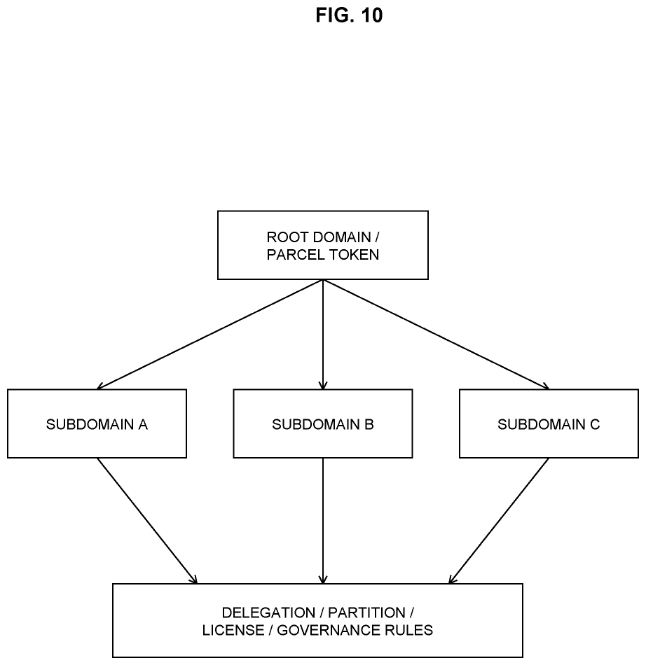

FIG. 11 illustrates upgradeable contract security, proxy-implementation switching, rollback, and audit logging.

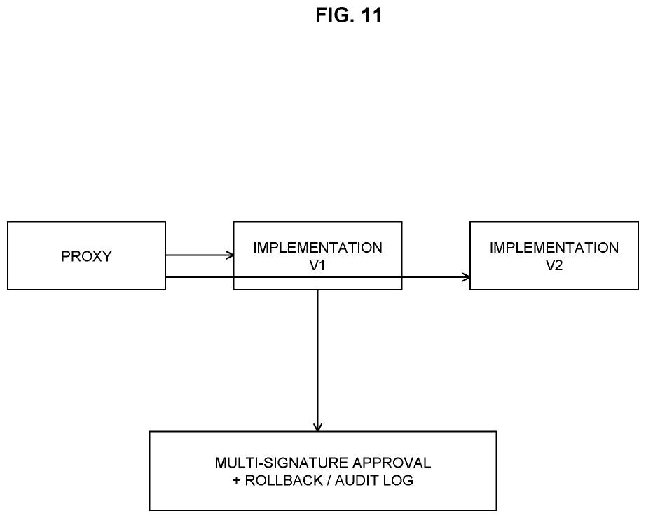

FIG. 12 illustrates quantum-secure communication, cross-chain verification, and light-client or bridge validation.

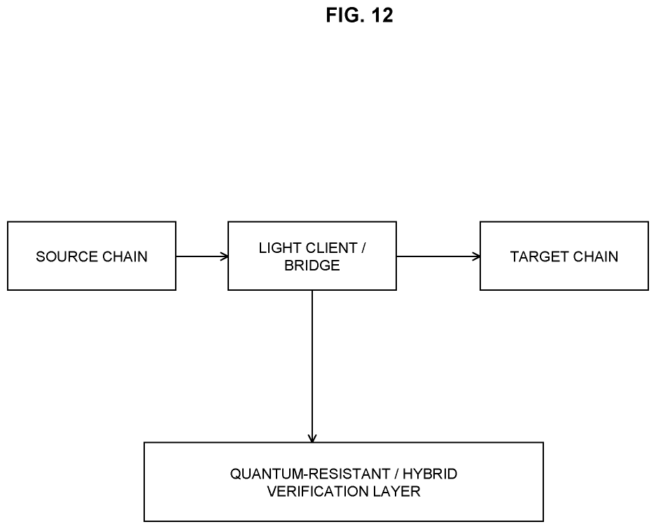

FIG. 13 illustrates supply-chain, IoT, provenance, and anti-counterfeiting embodiments.

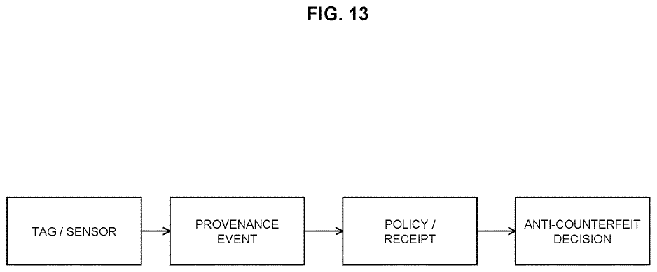

FIG. 14 illustrates DrAI/IoE device and biosensor-driven sector-application embodiments.

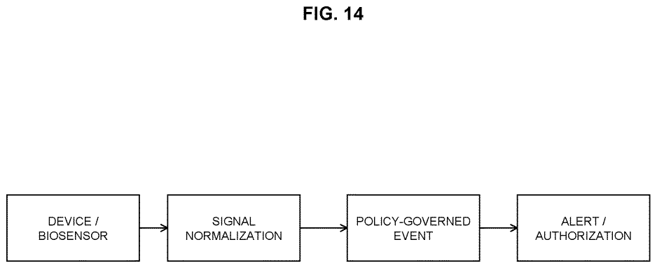

FIG. 15 illustrates health, mobility, pet, and asset-tracking application layers implemented on the same control spine.

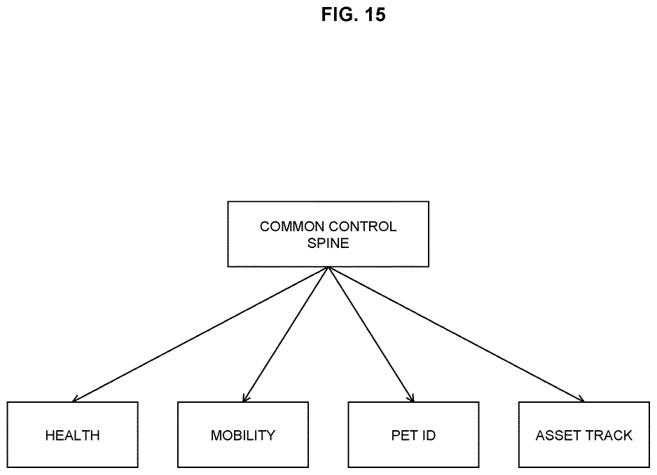

FIG. 16 illustrates computing hardware, edge terminals, server nodes, registry nodes, validator nodes, and external service rails.

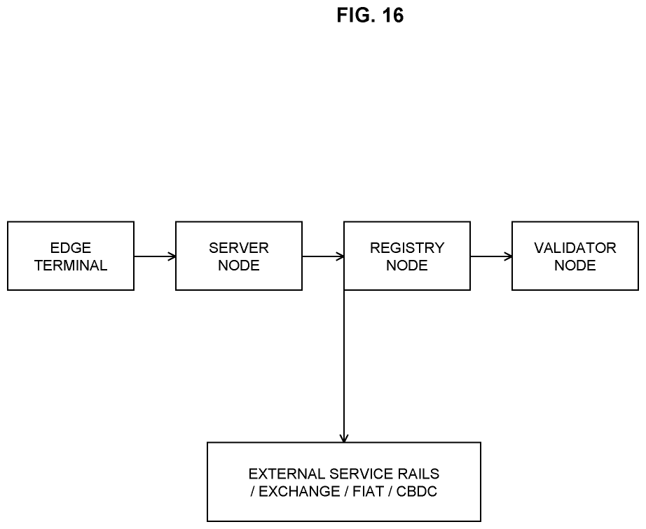

### DETAILED DESCRIPTION OF THE INVENTION

### Definitions and Drafting Conventions

As used herein, “subject” may refer to a person, device, enterprise, institution, regulator, sovereign entity, digital parcel owner, terminal operator, or any actor capable of holding or being associated with an identity anchor, credential, token, entitlement, or authorization state.

As used herein, “identity anchor” refers to a persistent machine-verifiable root association, which may include a decentralized identifier, public-key reference, wallet-bound credential, non-transferable token, verifiable credential, or other anchored identity representation.

As used herein, “object anchor” refers to a machine-verifiable anchor associated with a parcel, domain, subdomain, asset, instrument, registry entry, device, batch, pet, vehicle, or IoE object.

As used herein, “Time-Proof” refers to a machine-verifiable construct binding an event, request, evidence commitment, or object-state transition to a time reference, validity window, epoch or window identifier, and anti-replay value.

As used herein, “policy bundle” or “PackSet” refers to a signed, versioned rule set comprising authorization rules, role rules, source eligibility rules, weighting coefficients, privacy constraints, settlement conditions, remediation references, rollback constraints, or bounded-action directives.

As used herein, “signed endpoint record” refers to a signed or integrity-protected record mapping a domain identifier, basepoint identifier, parcel identifier, or subdomain identifier to one or more target endpoints or objects and associated verification metadata.

As used herein, “decision receipt” means a cryptographically verifiable receipt for an authorization decision, and “settlement receipt” means a cryptographically verifiable receipt for a listing, transfer, exchange, liquidation, or settlement transition.

### System Spine and Control Flow

In one embodiment, a human-readable identifier, subdomain identifier, parcel identifier, or other namespace label is provided to a namespace resolver. The resolver returns a signed endpoint record containing identity, policy, audit, minting, exchange, collateralization, and settlement endpoint information.

In one embodiment, an identity module authenticates a subject identity anchor or object anchor by verifying a decentralized identifier, public-key credential, verifiable credential, biometric approval, or predicate-based proof.

In one embodiment, an event-ingestion module receives a digitally signed event record, transaction request, evidence commitment, terminal-originated payment event, route-selection request, collateralization request, liquidation trigger, registry update, or application-layer event.

In one embodiment, a Time-Proof engine verifies that the event or request is valid inside a bounded time window and has not been replayed. The Time-Proof may include a nonce, replay counter, epoch tag, digest binding, or selected time-domain path.

In one embodiment, a policy container loads a signed, versioned policy bundle or PackSet and evaluates the event or request under source authorization rules, role rules, jurisdictional constraints, privacy rules, remediation directives, rollback limits, or bounded authorization outcomes.

In one embodiment, a transaction authorization and minting engine executes a single atomic state transition to authorize a protected action, bind or update a tokenized right or entitlement, generate a decision receipt, and anchor a digest of the transition in an append-only structure.

In one embodiment, a clearing and settlement module subsequently performs listing, transfer, exchange, conversion, collateralization, liquidation, or settlement and issues a settlement receipt linked to the same or a related digest reference.

In one embodiment, a policy-governed object may be a domain token, parcel token, evidence token, collateral token, registry entry, franchise token, terminal event, payment right, minting right, or license-gated artifact.

### Identity, Predicate Proofs, and Authorization FSM

The identity layer may issue, register, or bind decentralized identifiers, non-transferable identity tokens, biometric-authenticated credentials, or verifiable credentials to a subject anchor.

Predicate-based proof verification may be used to validate age thresholds, credit-score thresholds, sanctions non-membership, residency status, qualification categories, or entitlement predicates without exposing full source data.

A policy-enforced authorization finite-state machine may produce bounded outcomes including approve, deny, hold, limit, dual-confirmation, remediation-required, and rollback-eligible outcomes.

Each outcome may produce a machine-readable reason code, remediation reference, policy hash, policy version, score tier, or bounded-action record.

In certain embodiments, revocation or recovery of identity anchors is supported through threshold social recovery, guardian approval, or regulator-notified override procedures.

Namespace Routing, Digital Land, and Registry Objects

In one embodiment, namespace routing is used to discover identity endpoints, policy endpoints, exchange endpoints, audit endpoints, minting endpoints, and settlement endpoints without hard-coding those endpoints into every client.

In one embodiment, a digital-land or parcel token is associated with a root domain or subdomain, and one or more hierarchical subdomains can be delegated, partitioned, licensed, or inherited under policy-governed conditions.

A registry object may maintain parcel boundaries, domain labels, subdomain mappings, historical transfers, inheritance rules, freeze states, or delegated service rights.

In certain embodiments, the same namespace and registry fabric supports patents, domains, digital works, API artifacts, gated data resources, or other tokenized entitlements.

### Time Governance, Receipts, and Bounded Rollback

In one embodiment, a time-domain path or temporal namespace element is used to select a time window or eligibility window in which a request may be evaluated.

In one embodiment, the policy container applies a PackSet associated with the selected time window, jurisdiction, or route and may issue evidence receipts, denial receipts, rollback receipts, or settlement receipts according to a bounded state machine.

Bounded rollback may be controlled by rollback depth limits, span limits, impact-set constraints, anti-domino rules, or machine-readable remediation directives.

Selective disclosure or zero-knowledge proof of policy satisfaction may be used to preserve privacy while still proving eligibility, compliance, or correct application of a PackSet.

### Payment-to-Mint, Vault Allocation, and Terminal Edge

In one embodiment, a terminal-originated payment event is transformed into a minting event according to a policy bundle. Fees, service charges, or value-transfer metadata that would otherwise be captured by conventional networks may be redirected into a policy-governed minting, reward, or vault-allocation event.

A payment edge terminal may capture user identity, merchant identity, context signals, headers, or transaction semantics and submit a signed event that becomes a decision receipt, mint certificate, or settlement instruction.

Vault allocation may distribute resulting value to user vaults, merchant vaults, ecosystem vaults, lineage vaults, or policy-governed public-good accounts.

Tri-header or multi-header receipt structures may be used to preserve user, merchant, and system or regulator views of a payment-origin event.

### Route Optimization, FX, Collateralization, and Liquidation

Route selection may evaluate latency, liquidity, exchange-rate volatility, fees, compliance risk, and fraud probability to select an execution path.

Currency exchange optimization may use predictive models to time or structure execution in a way that reduces hidden conversion costs, improves liquidity use, or reduces settlement delay.

Assets, parcels, tokens, or rights may be collateralized using AI-driven valuation models, dynamic collateral-ratio management, and automated risk thresholding.

Liquidation may be triggered automatically when risk metrics, valuation changes, or threshold conditions are satisfied, subject to policy limits, liquidity safeguards, or bounded remediation logic.

### Exchange, Securities, and Market Infrastructure

In one embodiment, registry objects and tokenized instruments are listed, transferred, or traded through an exchange interface or securities-style disclosure layer.

Instruments may be behavior-backed, domain-anchored, parcel-anchored, or entitlement-based, and may include parent tokens, child tokens, fractional tokens, franchise tokens, or collateral-backed instruments.

Market layers may include listing rules, disclosure standards, rollback reserves, economic indices, or macro-aggregation engines used to derive local, regional, or sovereign-scale metrics.

A related branch may integrate co-ownership tokens, governance tokens, revenue-sharing instruments, or tokenized real-world collateral into the same control and receipt architecture.

### Security Infrastructure and Upgrade Governance

In one embodiment, one or more smart-contract components are upgradeable using a proxy-implementation architecture in which state is preserved and implementation pointers are switched under policy-controlled conditions.

Multi-signature approval, role-based access control, version registries, rollback to stable versions, sandbox testing, and anomaly-triggered freeze or lockdown can be used to secure upgrades.

These mechanisms are useful for exchanges, asset registries, minting systems, payment-to-mint terminals, and policy-governed settlement controllers.

### Quantum-Secure, Cross-Chain, and Oracle Layers

In one embodiment, communication and identity verification are protected using post-quantum, quantum-resistant, or hybrid cryptographic methods, including lattice-based, code-based, hash-based, quantum-key-distribution-assisted, or quantum-random-number-assisted techniques.

Cross-chain or cross-ledger validation may be achieved through light-client proofs, relay services, bridge attestations, or validator-backed interoperability layers.

Oracle services may be used for exchange rates, pricing, risk factors, external event confirmations, real-world signals, or settlement conditions, and oracle outputs may themselves be policy-bounded and receipt-linked.

Quantum-secure audit trails, quantum-secure identity verification, and quantum-safe bridge validation may optionally be combined with the system architecture.

### Sector-Specific and 999-Need Application Layers

In healthcare embodiments, the same identity, policy, receipt, and entitlement fabric may control screening, alerts, secure access, and selective disclosure of regulated data.

In supply-chain and IoT embodiments, sensors, tags, and provenance identifiers may feed the same receipt and policy architecture to support anti-counterfeiting, inventory analytics, asset valuation, and supply-chain finance.

In mobility embodiments, in-cabin sensing, driver-state monitoring, and policy-bounded intervention may be integrated with identity and safety controls.

In pet and device identity embodiments, object anchors, health signals, and location signals may be bound to tokenized identities and audited through the same receipt fabric.

In DrAI and IoE embodiments, domain-token and biosensor-based application layers may collect multimodal signals and submit policy-governed events into the same authorization and audit spine.

In digital-land and namespace embodiments, parcels, subdomains, franchises, stores, zones, or delegated service rights may be managed as policy-governed tokenized rights with inheritance, freeze, renewal, and partition rules.

In education, government-service, and licensing embodiments, predicate-based proof verification and receipt-linked authorization may control access to services, benefits, records, or regulated workflows.

In payment, exchange, and macro-financial embodiments, the same system may operate across ATMS-type rails, merchant events, FX-routing layers, collateralization engines, liquidity managers, exchange registries, and securities-style instrument layers.

### Representative Parent and Branch Use in Claim Support

Subject matter related to risk-controlled transaction authorization, hardware-rooted signing, bounded action outputs, and decision-path reconstruction may be supported by earlier execution-core parent materials.

Subject matter related to sovereign financial identity, domain deployment, reversible clearing, zero-knowledge audit, and post-quantum upgrade paths may be supported by earlier financial-identity and clearing roots.

Subject matter related to DID, biometrics, cross-chain identity verification, and privacy-preserving proofs may be supported by identity-core roots.

Subject matter related to PackSet logic, time-domain paths, evidence receipts, denial receipts, rollback receipts, settlement receipts, and bounded rollback may be supported by time-governance roots.

Subject matter related to payment-to-mint conversion, terminal-edge capture, tri-header receipts, and vault allocation may be supported by terminal and payment-to-mint roots.

Subject matter related to digital-land, parcel governance, subdomain issuance, and programmable registry objects may be supported by digital-land and honeycomb namespace branches.

Subject matter related to route optimization, foreign exchange, collateralization, liquidation, AI credit management, quantum-secured finance, upgrade governance, and related infrastructure may be supported by corresponding early finance and infrastructure roots preserved in the cross-reference section.

### Industrial Applicability and Commercial Use

The invention is industrially applicable to digital identity, banking, payments, exchange and settlement, collateral management, digital-land and registry systems, government services, supply-chain provenance, device and pet identity, IoE platforms, smart-contract infrastructure, and policy-controlled licensing systems.

The system can be licensed as a modular stack, including identity modules, policy-evaluation modules, namespace-routing modules, payment-to-mint modules, collateral and liquidation modules, exchange and securities modules, digital-land modules, or sector-application modules.

The architecture is suitable for transfer, assignment, field-of-use licensing, or sovereign or enterprise deployment because the core spine is technically coherent while allowing application-layer specialization.

### Additional Embodiments and Variations

The modules described herein may be implemented in software, firmware, hardware, trusted execution environments, hardware security modules, mobile devices, browser clients, cloud services, validators, ledger nodes, exchange gateways, or combinations thereof.

A ledger used herein may be public, private, consortium, permissioned, permissionless, append-only, or hybrid, and may store either full data, commitments, hashes, or selective references.

The same architecture may be applied to patents, domains, digital works, APIs, datasets, credentials, parcel rights, supply-chain objects, terminal receipts, or policy-governed service rights.

Unless expressly stated otherwise, no element, action, outcome, or sequence is required to occur in the precise order described, and modules may be combined, distributed, virtualized, or omitted while preserving the invention as recited in the claims.

The scope of protection is defined by the claims and their lawful equivalents.

1. A computer-implemented system for providing quantum-secure identity authentication, policy-controlled authorization, domain-namespace routing, interoperable minting, and multi-rail settlement across heterogeneous service domains, comprising: a namespace resolver configured to resolve a human-readable identifier, subdomain identifier, parcel identifier, or basepoint identifier to a signed endpoint record containing verification and routing metadata; an identity module configured to authenticate a subject identity anchor and associate the subject identity anchor with one or more decentralized identifiers, quantum-secure credentials, non-transferable identity-anchor tokens, or verifiable credential records; an event-ingestion module configured to receive a digitally signed event record, transaction request, evidence commitment, terminal-originated payment event, or sector-specific application event issued or attested by an authorized source; a Time-Proof engine configured to generate or verify a replay-resistant Time-Proof that binds the event record, transaction request, or evidence commitment to a time reference, validity window, and anti-replay value; a policy container configured to load and apply a signed, versioned policy bundle or PackSet defining source authorization rules, role rules, weighting coefficients, privacy constraints, jurisdiction constraints, remediation directives, and bounded authorization outcomes; an asset management module configured to register, issue, split, merge, license, suspend, revoke, or otherwise manage at least one domain-based token, evidence token, parcel token, authorization certificate, time-denominated value unit, or access-controlled state associated with the subject identity anchor; a transaction authorization and minting engine configured, upon successful verification of the subject identity anchor, the authorized source, the Time-Proof, and the signed, versioned policy bundle or PackSet, to execute a single atomic state transition that (i) authorizes access to a protected service, transaction, data resource, governance function, or application-layer workflow, (ii) binds an associated token, value unit, certificate, entitlement, or authorization state to the subject identity anchor or to a policy-governed target object, (iii) generates a decision receipt, mint certificate, or authorization certificate, and (iv) anchors a cryptographic digest of the transition in a tamper-evident data structure; and a clearing and settlement module configured to generate and store a settlement receipt for at least one listing, transfer, exchange, conversion, reconciliation, collateralization, liquidation, or settlement transaction involving the token, value unit, certificate, entitlement, or authorization state.

2. A computer-implemented method for providing quantum-secure identity authentication, policy-controlled authorization, domain-namespace routing, interoperable minting, and multi-rail settlement across heterogeneous service domains, the method comprising: authenticating a subject identity anchor and associating the subject identity anchor with one or more quantum-secure credentials, decentralized identifiers, identity-anchor tokens, or verifiable credential records; resolving, by a namespace resolver, a human-readable identifier, subdomain identifier, parcel identifier, or basepoint identifier to a signed endpoint record specifying one or more identity, policy, audit, minting, exchange, governance, or settlement endpoints; receiving a digitally signed event record, transaction request, evidence commitment, or terminal-originated payment event from an authorized source; generating or verifying a replay-resistant Time-Proof that binds the event record, transaction request, or evidence commitment to a time reference, validity window, and anti-replay value; loading and applying a signed, versioned policy bundle or PackSet that defines source authorization rules, role rules, privacy constraints, jurisdiction conditions, settlement conditions, remediation directives, or bounded authorization outcomes; executing, upon successful verification of the subject identity anchor, the authorized source, the Time-Proof, and the signed, versioned policy bundle or PackSet, a single atomic state transition that (i) authorizes access to a protected service, transaction, data resource, governance function, or application-layer workflow, (ii) binds an associated token, value unit, certificate, entitlement, or authorization state to the subject identity anchor or to a policy-governed target object, (iii) generates a decision receipt, mint certificate, or authorization certificate, and (iv) anchors a cryptographic digest of the transition in a tamper-evident data structure; and recording a settlement receipt for at least one subsequent transfer, conversion, exchange, reconciliation, collateralization, liquidation, or settlement transaction involving the token, value unit, certificate, entitlement, or authorization state.

3. A non-transitory computer-readable medium storing instructions that, when executed by one or more processors, cause the one or more processors to perform operations comprising: authenticating a subject identity anchor and associating the subject identity anchor with one or more decentralized identifiers, quantum-secure credentials, or identity-anchor tokens; resolving a human-readable identifier, subdomain identifier, parcel identifier, or basepoint identifier to a signed endpoint record containing identity, policy, audit, minting, exchange, governance, or settlement endpoint information; receiving a digitally signed event record, transaction request, evidence commitment, or sector-specific application event from an authorized source; generating or verifying a replay-resistant Time-Proof that binds the event record, transaction request, or evidence commitment to a time reference, validity window, and anti-replay value; loading and applying a signed, versioned policy bundle or PackSet defining source authorization rules, privacy constraints, jurisdiction conditions, bounded authorization outcomes, and remediation directives; executing a single atomic state transition that authorizes a protected action, binds an associated token, value unit, certificate, entitlement, or authorization state, generates a decision receipt, mint certificate, or authorization certificate, and anchors a digest of the transition in a tamper-evident data structure; and generating a settlement receipt associated with at least one transfer, exchange, conversion, reconciliation, collateralization, liquidation, or settlement transaction involving the token, value unit, certificate, entitlement, or authorization state.

4. The system of claim 1, wherein the subject identity anchor comprises or is associated with a decentralized identifier, a public-key reference, a device-bound credential, a biometric-authenticated credential, a social-recovery credential, or a verifiable credential record used for predicate-based proof verification.

5. The system of claim 1, wherein the signed endpoint record comprises one or more endpoint identifiers, signature material, key identifiers, policy hashes, version identifiers, validity metadata, and routing metadata, and maps a namespace label, parcel label, or subdomain label to a decentralized identifier, target object, or service endpoint.

6. The system of claim 1, wherein the Time-Proof comprises a timestamp or time reference, a nonce, replay-prevention value, epoch or window identifier, validity window, and cryptographic binding to a transaction digest, asset identifier, or evidence commitment.

7. The system of claim 1, wherein the signed, versioned policy bundle or PackSet defines bounded authorization outcomes including approve, deny, hold, limit, dual-confirmation, remediation, or rollback-eligible outcomes, and further stores a machine-readable reason code or remediation reference.

8. The system of claim 1, wherein the transaction authorization and minting engine binds the associated token, value unit, certificate, entitlement, or authorization state non-transferably or conditionally transferably to the subject identity anchor, a namespace-bound object, a parcel-bound object, or a policy-governed beneficiary account.

9. The system of claim 1, wherein the asset management module manages an NFT-based domain token, parcel token, franchise token, evidence token, or collateral token representing at least one namespace right, subdomain right, digital-land right, ownership right, use right, service right, or policy-bounded entitlement.

10. The system of claim 1, further comprising an artificial-intelligence governance module configured to generate a risk score, trust score, anomaly determination, credit profile, valuation score, or route-optimization output and to adjust a bounded action, fee parameter, collateral ratio, or settlement pathway responsive thereto.

11. The system of claim 1, wherein the clearing and settlement module interoperates with ATMS-compatible infrastructure, exchange gateways, liquidity venues, ISO 20022 message rails, fiat or CBDC connectors, oracle-assisted settlement modules, or cross-ledger bridges.

12. The system of claim 1, wherein the domain identifier or subdomain identifier is associated with a temporal namespace element or time-domain path governing activation, suspension, renewal, expiry, rollback depth, or time-bounded entitlement release.

13. The method of claim 2, further comprising storing an append-only decision digest, settlement digest, impact-set digest, or audit digest without exposing all underlying private data associated with the request or transaction.

14. The method of claim 2, wherein failed verification of the subject identity anchor, the authorized source, the Time-Proof, or the signed, versioned policy bundle or PackSet causes issuance of a denial receipt comprising a reason code and a remediation reference.

15. The method of claim 2, wherein the protected service, transaction, data resource, governance function, or application-layer workflow is associated with finance, healthcare, education, government service, supply-chain provenance, mobility, digital-land governance, pet or device identity, or asset tracking.

16. The method of claim 2, wherein the decision receipt and the settlement receipt are linked by a shared identifier, state reference, digest reference, or transaction reference.

17. The non-transitory computer-readable medium of claim 3, wherein the signed endpoint record specifies distinct endpoints for identity verification, predicate-proof verification, policy evaluation, audit logging, minting, exchange, governance, collateralization, or settlement.

18. The non-transitory computer-readable medium of claim 3, wherein the instructions implement a quantum-resistant, post-quantum, or hybrid cryptographic scheme including at least one of lattice-based, hash-based, code-based, quantum-key-distribution-assisted, or quantum-random-number-assisted protection.

19. The system of claim 1, wherein the asset management module supports policy-controlled splitting, merging, licensing, delegation, suspension, revocation, freezing, partial clawback, partitioning, or inheritance of a tokenized right or parcel-bound right.

20. The system of claim 1, wherein a terminal-originated payment event, collateralization event, liquidation event, or namespace-authorized asset event is transformed into a minting event, audit event, settlement event, or governance event according to the policy bundle or PackSet.
